(19) United States
(12) Patent Application Publication
(10) Pub. No.: US 2010/0161502 A1
(43) Pub. Date: Jun. 24, 2010

(54) APPARATUS AND METHOD FOR EVALUATING AN ENERGY SAVING BEHAVIOR

(75) Inventors: Toshimitsu KUMAZAWA, Kanagawa-ken (JP); Koji KIMURA, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/640,698

(22) Filed: Dec. 17, 2009

(30) Foreign Application Priority Data
Dec. 19, 2008 (JP) 2008-324324

(51) Int. Cl. G06Q 99/00; G06F 17/30

(52) U.S. Cl. 705/317

(57) ABSTRACT

An appliance measurement interface inputs an appliance measured value from each appliance. The appliance measured value includes an electric energy consumption, a usage intensity and a usage frequency of the appliance. An appliance information count unit calculates an average of the appliance measured value in an evaluation span, and outputs an appliance information as the average of the appliance measured value. An evaluation unit acquires a first appliance information in a first evaluation span as an evaluation object period and a second appliance information in a second evaluation span as a comparison object period from the appliance information, and calculates an evaluation value by applying the first appliance information and the second appliance information to an evaluation function. A display unit displays an evaluation result of an energy saving behavior based on the evaluation value.

### CROSS-REFERENCE TO RELATED APPLICATIONS

This application is based upon and claims the benefit of priority from Japanese Patent Application No. 2008-324324, filed on Dec. 19, 2008; the entire contents of which are incorporated herein by reference.

### FIELD OF THE INVENTION

The present invention relates to an apparatus and a method for evaluating a user's behavior related with an energy saving.

### BACKGROUND OF THE INVENTION

With regard to a search report by the National Consumer Affairs Center of Japan, the people's interest degree for energy saving is above ninety percent. However, the energy consumption in a public welfare section continually increases as before, and there is a gap between the people's consciousness and behavior for environment.

As a method to domestically execute the energy saving, an improvement of ability of an energy-using product or a house, and a control of an energy usage quantity, are selected. Furthermore, as to the control of the energy usage quantity, an automatic control by hardware, and an indirect control by presenting information, are included. In the control of the energy usage quantity, by adjusting an energy-using product to omit useless operation based on information from a sensor (a temperature sensor or a pyroelectric sensor), the energy saving is attempted. As a simple example, a method for switching ON/OFF of a lighting apparatus by a human detection sensor is applied. In the indirect control by presenting information, a target value and an actual value of the energy usage quantity are displayed as a comparison format or a ranking format with another person, and the energy saving is attempted for a user (person in life) by raising a consciousness and arousing a behavior for the energy saving. The present invention belongs to the indirect control.

As a problem occurred in the indirect control, the effect does not continue for a long time, or the effect is largely different for each person. In order to arouse the energy saving behavior, presentation of evaluation of not only an electric energy consumption but the energy saving behavior itself is very effective to raise the user's motivation.

As to a prior method for evaluating the energy saving behavior, when an electric power is above a threshold, the purport is notified to a consumer. After this notification, when the electric power falls within a predetermined period, it is decided that the energy saving behavior is performed. This method is disclosed in JP-A H11-248763 (Kokai). Furthermore, as another prior method for evaluating the energy saving behavior, ON time of the appliance is detected by measuring the electric energy consumption, and the user's energy saving behavior is evaluated by a length of the ON time. This method is disclosed in JP-A 2005-189102 (Kokai).

As to the energy saving behavior performed while utilizing the appliance, behaviors of two kinds are included. As to a first behavior, a usage frequency is reduced, i.e., a usage time or the number of usage is reduced. As to a second behavior, a usage intensity is adjusted, i.e., a set temperature or a set illuminance is fallen. However, in the prior art, the energy saving behavior cannot be exhaustively evaluating by referring to both the usage frequency and the usage intension. Furthermore, factors (a temperature, a humidity, or a stay time of person) affecting on usage of the appliance is not taken into consideration. Accordingly, the energy saving cannot be properly evaluated.

### SUMMARY OF THE INVENTION

The present invention is directed to an apparatus and a method for evaluating the energy saving behavior by not only an electric power of an appliance but the usage frequency and the usage intension of the appliance.

According to an aspect of the present invention, there is provided an apparatus for evaluating an energy saving behavior, comprising: an appliance measurement interface configured to input an appliance measured value from each appliance, the appliance measured value including an electric energy consumption, a usage intensity and a usage frequency of the appliance; an appliance measured value database configured to store the appliance measured value; an appliance information count unit configured to calculate an average of the appliance measured value in an evaluation span; an appliance information database configured to store an appliance information as the average of the appliance measured value; an evaluation unit configured to acquire a first appliance information in a first evaluation span and a second appliance information in a second evaluation span from the appliance information database, and calculate an evaluation value by applying the first appliance information and the second appliance information to an evaluation function, the first evaluation span being an evaluation object period, the second evaluation span being a comparison object period; an evaluation result database configured to store the evaluation value; and a display unit configured to display an evaluation result of the energy saving behavior based on the evaluation value.

### BRIEF DESCRIPTION OF THE DRAWINGS

FIG. 1 is a schematic diagram of an eco network having a behavior evaluation apparatus of the first embodiment.

FIG. 2 is a block diagram of the behavior evaluation apparatus of the first embodiment.

FIG. 3 is a flow chart of processing of the behavior evaluation apparatus in FIG. 2.

FIG. 4 is a schematic diagram of contents of an appliance measured value database 13 in FIG. 2.

FIG. 5 is a schematic diagram of contents of an appliance information database 15 in FIG. 2.

FIG. 6 is a schematic diagram of contents of a metrics database 17 in FIG. 2.

FIG. 7 is a schematic diagram of contents of an evaluation result database 18 in FIG. 2.

FIG. 8 is a schematic diagram of contents of an advice database 20 in FIG. 2.

FIG. 9 is a schematic diagram of one display example of an evaluation result of the first embodiment.

FIG. 10 is a schematic diagram of another display example of the evaluation result of the first embodiment.

FIG. 11 is a schematic diagram of the other display example of the evaluation result of the first embodiment.

FIG. 12 is a block diagram of the behavior evaluation apparatus of the second embodiment.

FIG. 13 is a flow chart of processing of the behavior evaluation apparatus in FIG. 12.

FIG. 14 is a schematic diagram of contents of an external condition measured value database 47 in FIG. 12.

FIG. 15 is a schematic diagram of contents of an external condition database 49 in FIG. 12.

FIG. 16 is a schematic diagram of contents of a metrics database 37 in FIG. 12.

FIG. 17 is a schematic diagram of contents of an evaluation result database 38 in FIG. 12.

FIG. 18 is a schematic diagram of one display example of an evaluation result of the second embodiment.

FIG. 19 is a schematic diagram of another display example of an evaluation result of the second embodiment.

FIG. 20 is a schematic diagram of the other display example of an evaluation result of the second embodiment.

### DETAILED DESCRIPTION OF THE EMBODIMENTS

Hereinafter, embodiments of the present invention will be explained by referring to the drawings. The present invention is not limited to the following embodiments.

### The First Embodiment

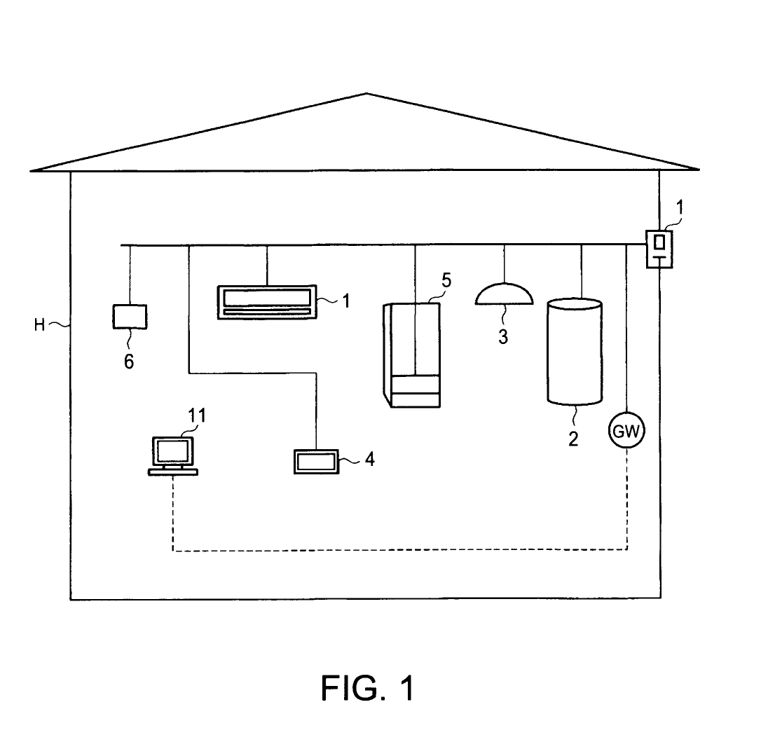

FIG. 1 is a schematic diagram of a network composition to which a behavior evaluation apparatus 11 of the first embodiment is applied. In a house H of FIG. 1, home appliances such as an air conditioner 1, an electric water heater 2, a lighting apparatus 3, a television 4, and an electric refrigerator 5, are set. In these home appliances, a transmission medium is installed to compose a home network, and data transmission from each appliance is possible. For example, the home network is disclosed in “The Journal of the Institute of Image Information and Television Engineers, Vol. 59, No. 5, pp. 705-709”. In FIG. 1, a wireless communication apparatus receives data transmitted from the home appliances, and transmits data to the behavior evaluation apparatus 11 via a gateway GW.

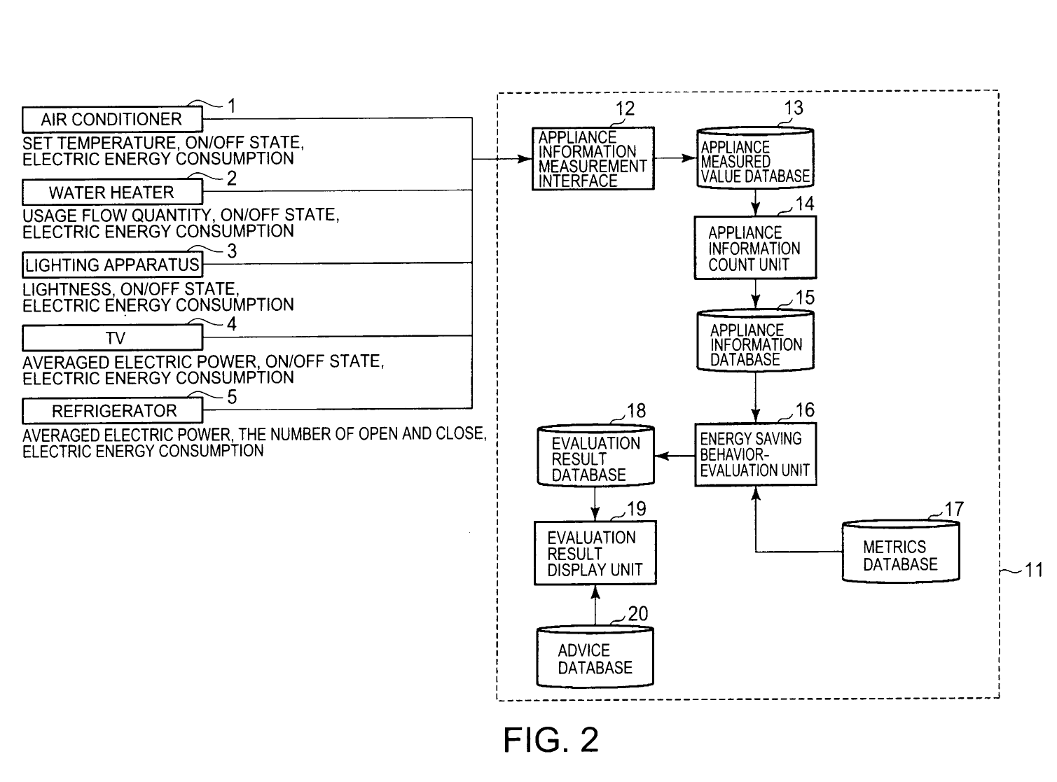

FIG. 2 is a block diagram of the behavior evaluation apparatus 11 wirelessly connected to the home appliances. As shown in FIG. 2, the behavior evaluation apparatus 11 includes an appliance information measurement interface 12. This interface 12 inputs data from the home appliances (the air conditioner 1, the water heater 2, the lighting apparatus 3, the television 4, the refrigerator 5), and measures the data. Concretely, based on the data transmitted from the home appliances, the appliance information measurement interface 12 measures an electric energy consumption, a usage intensity (strength and weakness), a usage frequency and a usage time of each appliance by a general method, and outputs a measurement result as an appliance measured value.

The appliance information measurement interface 12 is connected to an appliance information count unit 14 via an appliance measured value database 13 to store the appliance measured value. The appliance information count unit 14 counts data stored in the appliance measured value database 13. The appliance information count unit 14 is connected to an energy saving behavior-evaluation unit 16 via an appliance information database 15, and sends counted data to the energy saving behavior-evaluation unit 16. The energy saving behavior-evaluation unit 16 is connected to a metrics database 17 storing an evaluation function, and evaluates an energy saving behavior based on the counted data and the evaluation function. The energy saving behavior-evaluation unit 16 stores an evaluation result into an evaluation result database 18.

The evaluation result database 18 is connected to an evaluation result display unit 19. The evaluation result display unit 19 accesses an advice database 20 based on the evaluation result of the evaluation result database 18, extracts advice data corresponding to the evaluation result from the advice database 20, and displays the advice data with the evaluation result.

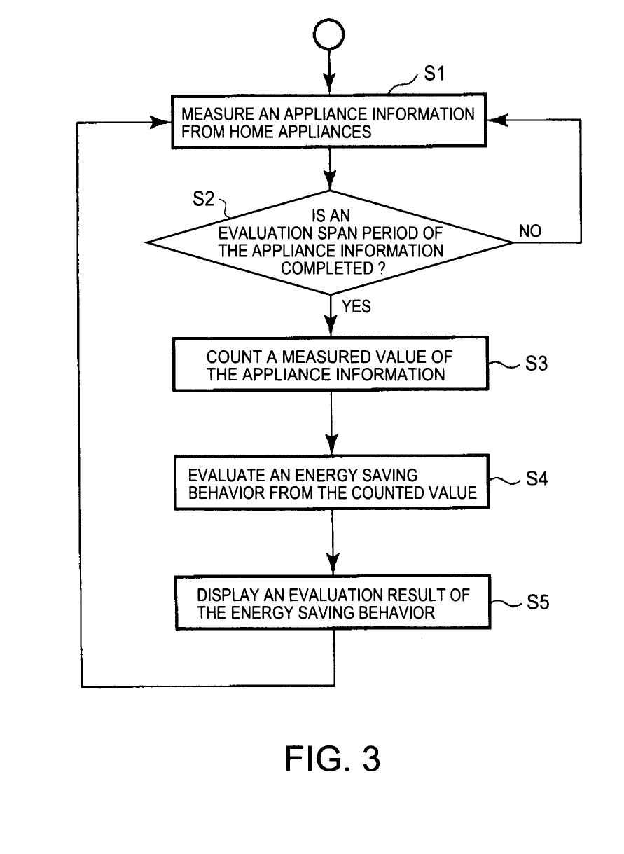

Operation of the behavior evaluation apparatus 11 is explained by referring to a flow chart of FIG. 3. At S1 in FIG. 3, the appliance information measurement interface 12 measures the electric power of the home appliance, and a metric (such as a set or a state of operation of the appliance) measurable as a result of the energy saving behavior.

In each appliance (the air conditioner 1, the water heater 2, the lighting apparatus, the television 4, the refrigerator 5), a metrics to measure a usage intensity and a usage frequency of the appliance is respectively indicated. The metrics to measure the usage intensity is a parameter (such as a set temperature of the air conditioner, a lightness of the lighting apparatus, or a wind power of a fun) affecting on the electric power, and adjustable by a user. The metrics to measure the usage frequency is a parameter (such as a view time of the TV 4, the times of use of a toaster, or the number of open and close of the refrigerator 5) affecting on usage time. The electric energy consumption is calculated as a product of the electric power and the usage time. Accordingly, a usage intensity metrics and a usage frequency metrics are regarded as a result of behavior affecting on increase/decrease of the electric energy consumption. By measuring the usage intensity metrics and the usage frequency metrics of each appliance, these metrics are used to evaluate an energy behavior saving (a behavior contributing to deletion of the energy). The metrics of each appliance is previously stored in the metrics database as a format of FIG. 6. In the first embodiment, the energy is an electric power. However, evaluation of the energy saving behavior is possible for other energy such as a gas or a lamp oil.

Next, concrete operation of data measurement (S1) is explained. In the first embodiment, the appliance as a measurement object is the air conditioner 1, the water heater 2, the lighting apparatus 3, the television 4, and the refrigerator 5. The lighting apparatus 3 measures “lightness” as the usage intensity metrics, “ON/OFF state” and “electric power consumption” as the usage frequency metrics at a predetermined interval, and transmits measurement data to the appliance information measurement interface 12 at the predetermined interface. In this case, the appliance information measurement interface inputs the measured data of each appliance by accessing each appliance.

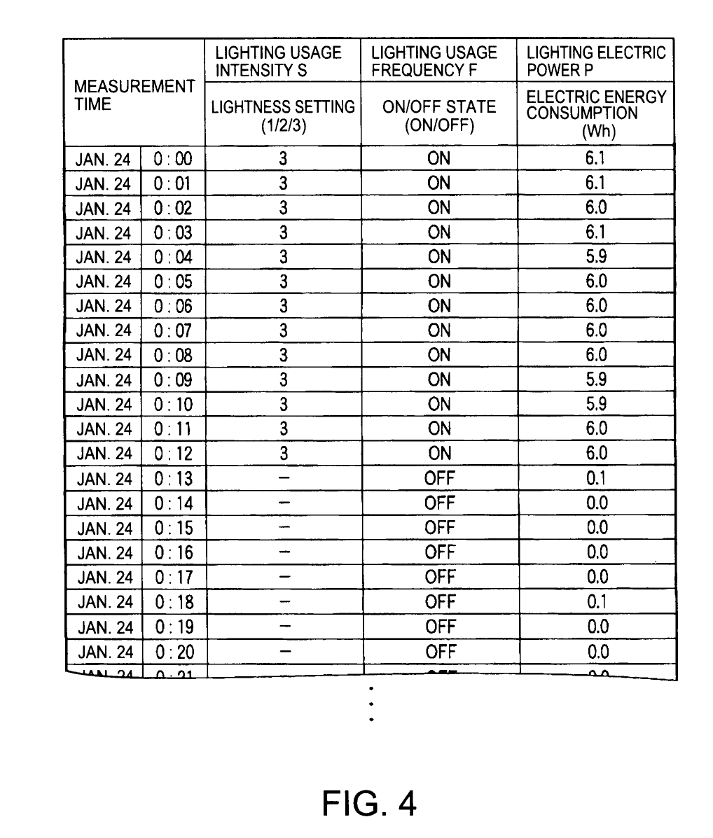

In the first embodiment, measurement and transmission of data are executed every one minute. The appliance information measurement interface 12 records the measured data into the appliance measured value database 12 as a format of FIG. 4. In the same way, the measured values of the air conditioner 1, the water heater 2, the TV 4 and the refrigerator 5, are respectively recorded.

As to the air conditioner 1, “set temperature” as the usage intensity metrics, “ON/OFF state” and “electric power consumption” as the usage frequency metrics are measured, and recorded into the appliance measured value database 13 via the appliance information measurement interface 12. As to the water heater 2, “usage flow quantity” as the usage intensity metrics, “ON/OFF state” and “electric energy consumption” as the usage frequency metrics are measured, and recorded into the appliance measured value database 13 via the appliance information measurement interface 12. As to the television 4, “averaged electric power” as the usage intensity metrics, “ON/OFF state” and “electric power consumption” as the usage frequency metrics are measured, and recorded into the appliance measured value database 13 via the appliance information measurement interface 12. As to the refrigerator 5, “averaged electric power” as the usage intensity metrics, “the number of open and close” and “electric power consumption” as the usage frequency metrics are measured, and recorded into the appliance measured value database 13 via the appliance information measurement interface 12. In this case, a measurement function of each appliance may be installed onto the appliance, or may be realized by an adapter externally connected to the appliance.

Data measurement (S1) is executed at a predetermined interval, i.e., every one minute. After data measurement, it is decided whether a unit period of evaluation (For example, one day) is completed (S2). In case of decision “NO”, processing is returned to S1, and data measurement is executed again for next one minute. In case of “YES”, count of the measured value (S3) is executed.

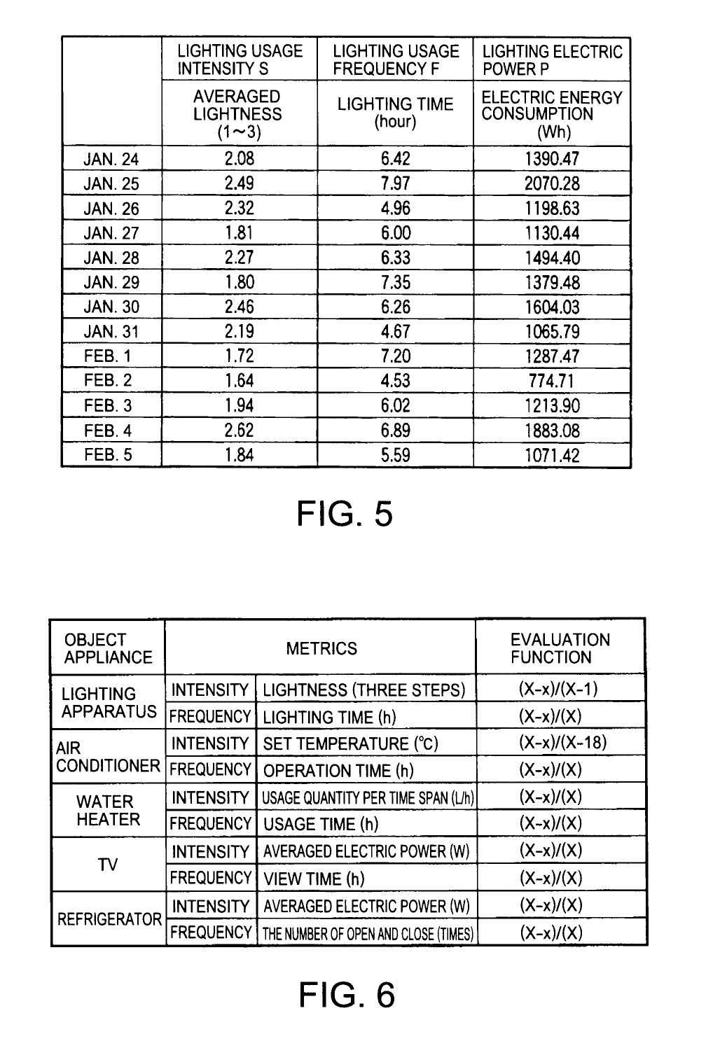

At S3, as to the appliance measured value recorded at predetermined interval in the appliance measured value database 13, the appliance information count unit 14 counts by a unit period of evaluation. In case of the appliance measured value of the lighting apparatus 3, the appliance information count unit 14 calculates an average of the lightness during “ON time” period, a total of duration of “ON” state, and a total of the electric energy consumption, for one day. These counted data are recorded into the appliance information database 15 as a format of FIG. 5. In the same way, the appliance measured values of the air conditioner 1, the water heater 2, the television 4 and the refrigerator 5, are counted. As a basic method for counting, the usage intensity metrics is calculated as an average in a unit period of evaluation, the usage frequency metrics is calculated as a total in the unit period of evaluation, and the electric energy consumption is calculated as a total in the unit period of evaluation.

After completing the count, evaluation of an energy saving behavior (S4) is executed. At S4, the energy saving behavior is evaluated using the metrics and the electric energy consumption recorded in the appliance information database 15. In the first embodiment, an evaluation object period is yesterday (one day), and a comparison object period is last week (one week). By comparing an energy saving behavior of yesterday with an energy saving behavior averaged (one day behavior) from last week, the energy saving behavior of yesterday is evaluated.

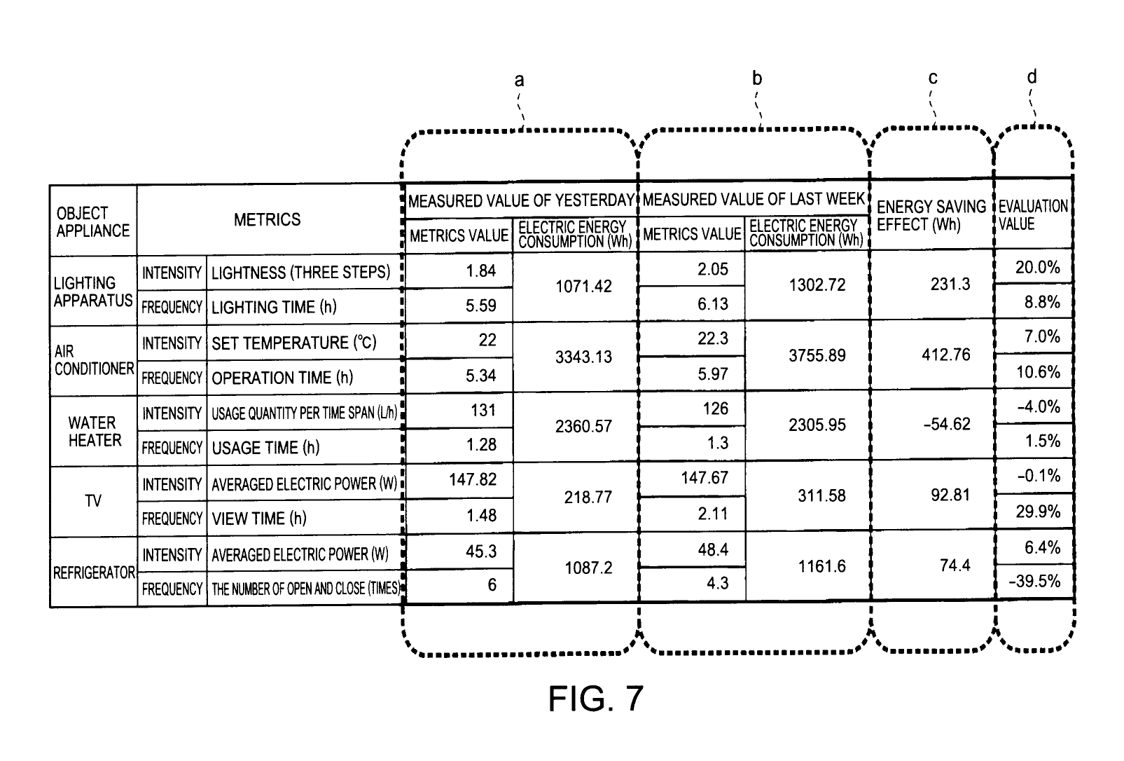

For example, the energy saving behavior-evaluation unit 16 is composed by a processor. The energy saving behavior-evaluation unit 16 acquires appliance information of yesterday and last week from the appliance information database, evaluates the appliance information of yesterday using an evaluation function stored in the metrics database 17 as a format of FIG. 6, and records this evaluation result into the evaluation result database 18 as a format of FIG. 7. Concretely, a counted value (lighting usage intensity S: 1.84, lighting usage frequency F: 5.59, lighting electric power P: 1071.42) of yesterday (Feb. 5) is acquired from the appliance information database 15, and recorded into the evaluation result database 18 (“a” in FIG. 7).

As to the evaluation function in metrics data of FIG. 6, a metrics value of comparison object (previous one week) is described as “X”, and a metrics value of evaluation object (yesterday) is described as “x”. In the first embodiment, an improvement value is calculated by subtracting the metrics value “x” of evaluation object from the metrics value “X” of comparison object, and a difference value (X−1) is calculated by subtracting a minimum “1” of metrics value from the metrics value “X” of comparison object. An evaluation function is represented by dividing the improvement value with difference value (X−1), i.e., the evaluation function is (X−x)/(X−1) .

Next, counted values of last week (January 29˜February 4) are acquired from the appliance information database 15. An average value (one day) of the usage intensity metrics, the usage frequency metrics and the electric energy consumption, is respectively calculated from the counted values of last week, and recorded into the evaluation result database 18 (“b” in FIG. 7). A difference of the electric energy consumption between a measured value of yesterday and an average value of last week is calculated as an energy saving effect, and recorded into the evaluation result database 18 (“c” in FIG. 7). Last, an evaluation value of each appliance is calculated using the evaluation function stored in the metrics database 11, and stored in the evaluation result database 18 (“d” in FIG. 7).

After evaluating the energy saving behavior, display of the evaluation result (S5) is executed. At S5, the evaluation result display unit 19 displays the evaluation result of the energy saving behavior in an evaluation object period to a user, based on the evaluation value and the advice data. In the first embodiment, by displaying information of three kinds on a display terminal based on the evaluation result database 18, the evaluation result is presented to the user.

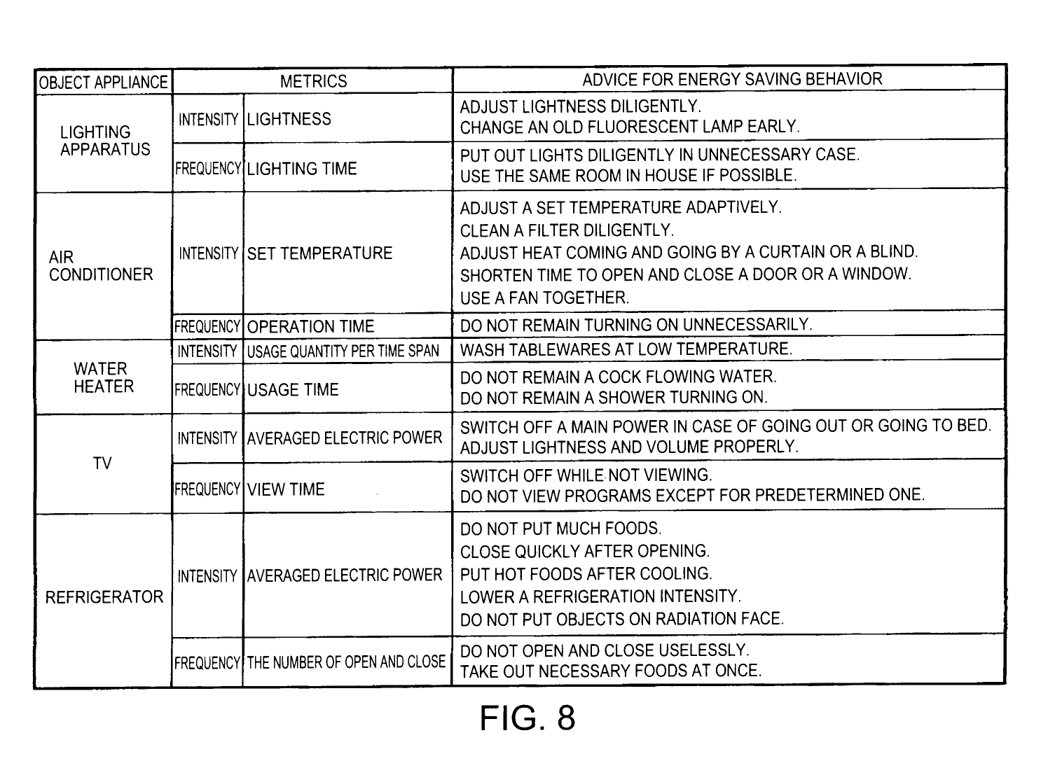

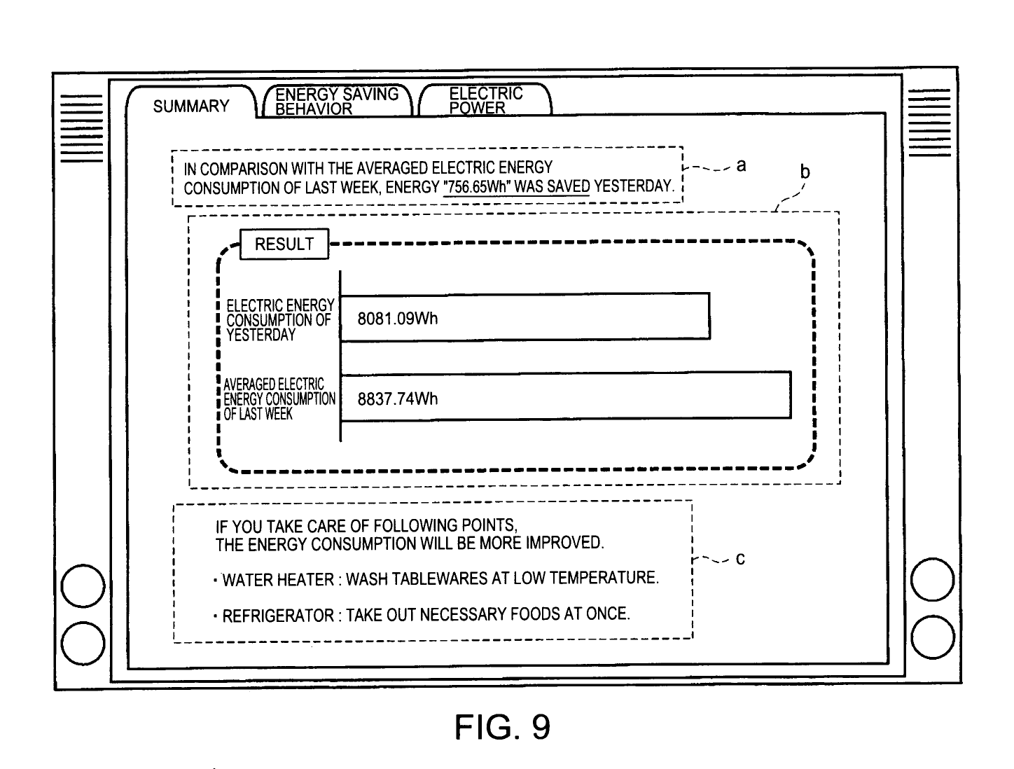

In a display example of FIG. 9, a total of the energy saving effect (“c” in FIG. 7) stored in the evaluation result database 18 is displayed (“a” in FIG. 9), and a total of the electric energy consumption of yesterday (“a” in FIG. 7) and last week (“b” in FIG. 7) is respectively displayed as a bar graph (“b” in FIG. 9). Furthermore, the advice database 20 stores an advice of each metrics of the appliance as a format of FIG. 8. In the display example of FIG. 9, two advice corresponding to two metrics (−4.0%, −39.5%) having low evaluation values (“d” in FIG. 7) are displayed (“c” in FIG. 9). In this way, by using the usage intensity metrics and the usage frequency metrics of each appliance, a concrete advice is properly presented to the user.

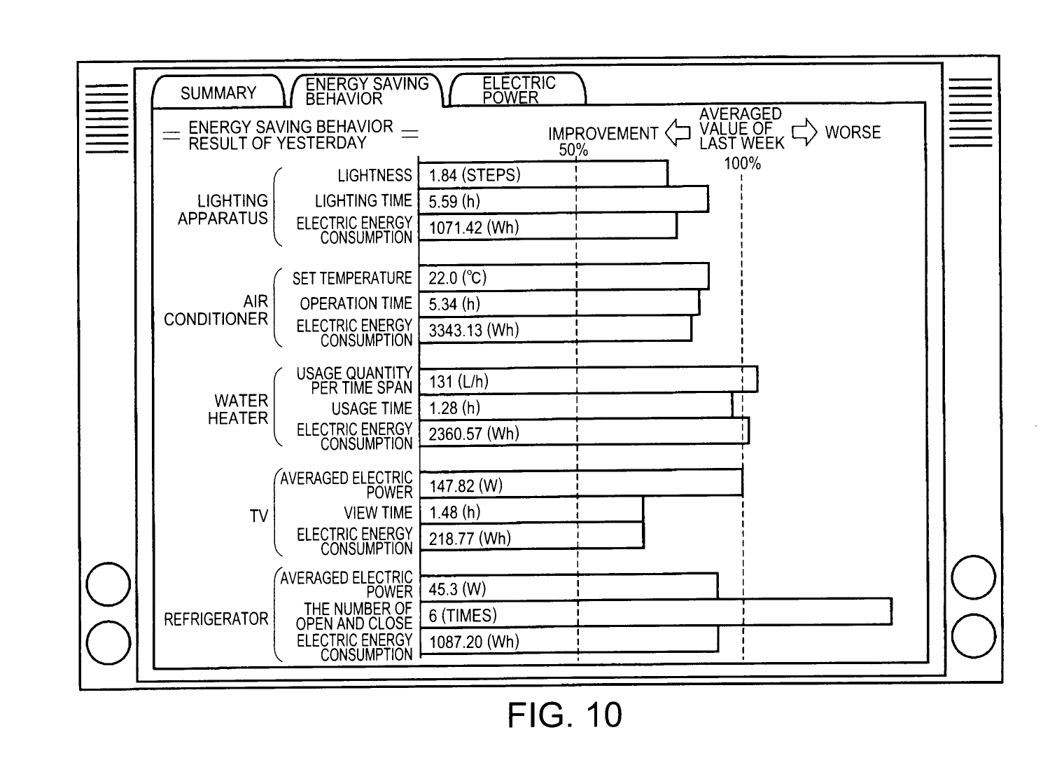

In another display example of FIG. 10, in case that the metrics value and the electric energy consumption of last week (“b” in FIG. 7) is respectively set as 100%, a ratio of the metrics value and the electric energy consumption of yesterday (“a” in FIG. 7) is respectively shown as a bar graph. In this example, a cause to increase/decrease the electric energy consumption is clearly shown. For example, in comparison with last week, the electric energy consumption of the water heater 2 of yesterday increased, because the usage quantity per time span of yesterday increased.

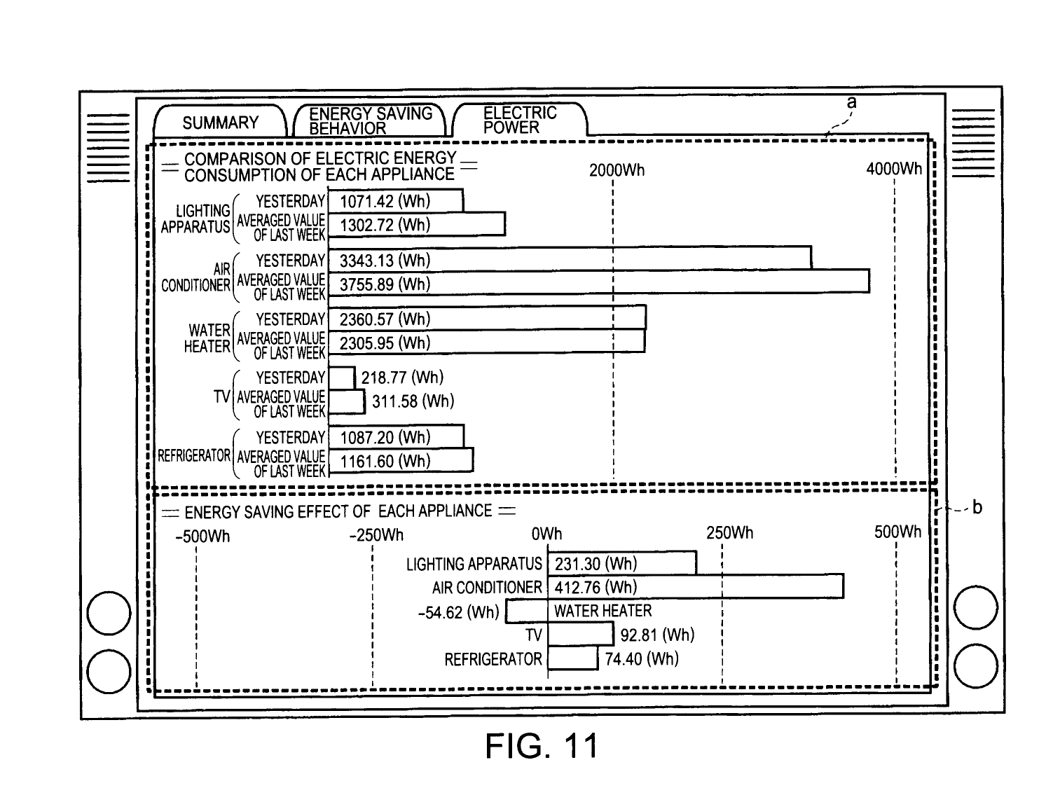

In the other display example of FIG. 11, the electric energy consumption of each appliance of yesterday and last week (“a” and “b” in FIG. 7) is respectively displayed as a bar graph (“a” in FIG. 11), and the energy saving effect (“c” in FIG. 7) of each appliance is displayed as a bar graph (“b” in FIG. 11). In this example, by showing an absolute amount, the user can understand which appliance to positively perform the energy saving behavior.

Above-mentioned advice and the evaluation result may be presented to the user by another medium such as a speech or an E-mail. Hereinafter, measurement of appliance information is repeatedly executed at S1, and the appliance information is repeatedly evaluated in the unit period of evaluation.

### The Second Embodiment

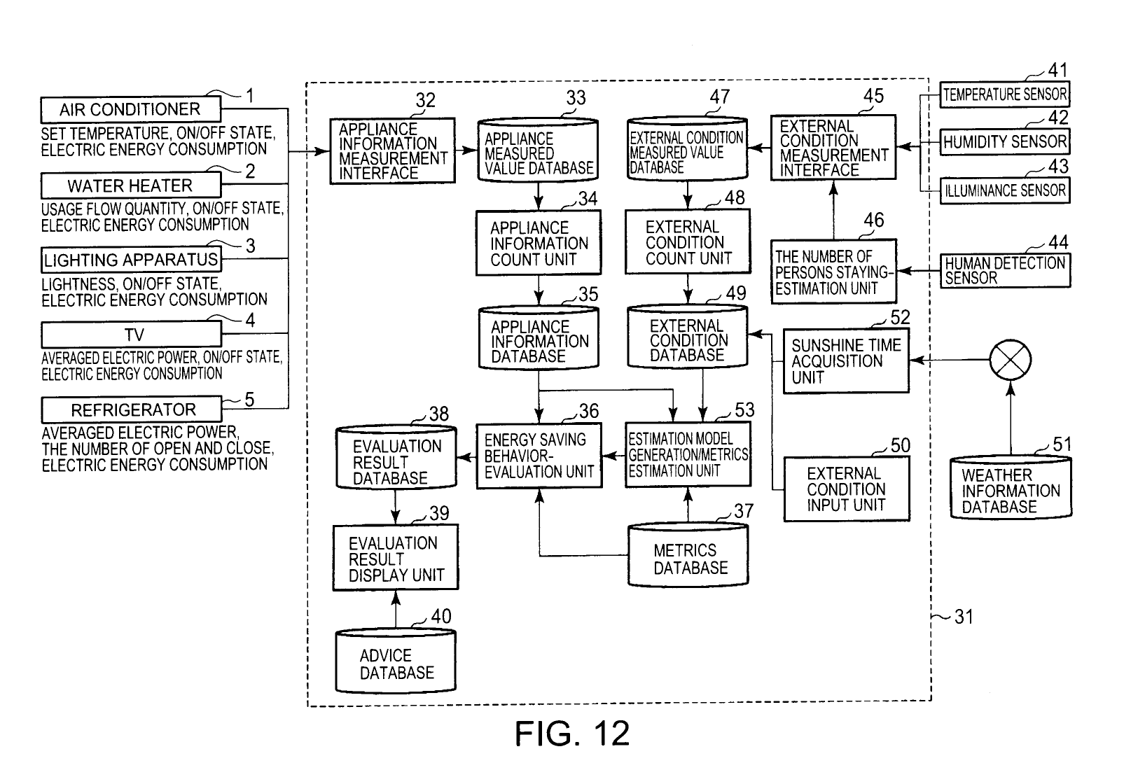

A behavior evaluation apparatus 31 of the second embodiment is explained by referring to FIG. 12. In the same way as the first embodiment, the behavior evaluation apparatus 31 includes an appliance information measurement interface 32 to input data from the air conditioner 1, the water heater 2, the lighting apparatus 3, the television 4 and the refrigerator 5. The appliance information measurement interface 32 is connected to an energy saving behavior-evaluation unit 36 via an appliance measured value database 33, an appliance information count unit 34 and an appliance information database 35. The energy saving behavior-evaluation unit 36 is connected to a metrics database 37, and connected to an evaluation result display unit 39 via an evaluation result database 38. The evaluation result display unit 39 is connected to an advice database 40. Above-mentioned component is substantially same as the first embodiment.

In the behavior evaluation apparatus 31 of the second embodiment, an external condition measurement interface 45 to measure data from a temperature sensor 41, a humidity sensor 42 and an illuminance sensor 43 (each set in a house) is equipped. Furthermore, a number of persons staying-estimation unit 46 to estimate the number of persons staying based on data from a human detection sensor 44 (set in the house) is equipped.

The external condition measurement interface 45 is connected to an external condition database 49 via an external condition measured value database 47 to store an external condition measured value, and an external condition count unit 48 to count the external condition measured value. The external condition database 49 is connected to an external condition input unit 50 and a sunshine time acquisition unit 52 to calculate a sunshine time based on weather information from a weather information database 51. The external condition database 49 stores data from the external condition count unit 48, the external condition input unit 50 and the sunshine time acquisition unit 52.

The external condition database 49 is connected to an estimation model generation/metrics estimation unit 53. The estimation model generation/metrics estimation unit 53 is composed by a processor. As explained afterwards, the estimation model generation/metrics estimation unit 53 generates an estimation model based on data from the appliance information database 35, the metrics database 37 and the external condition database 49, estimates a metrics and an electric energy consumption of each appliance, and sends the estimated value to the energy saving behavior-evaluation unit 36.

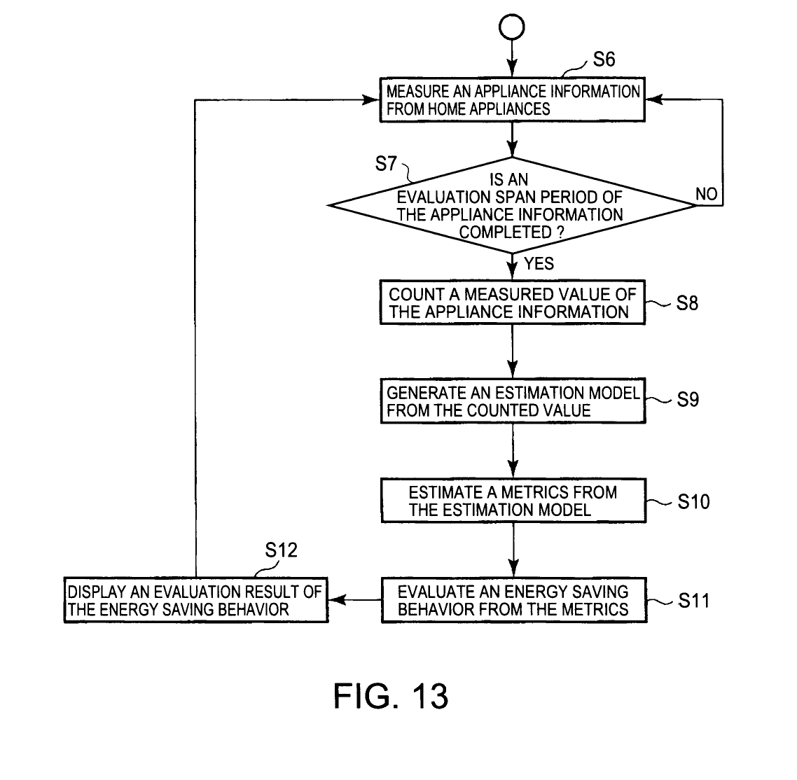

Next, operation of the behavior evaluation apparatus 31 is explained by referring to a flow chart of FIG. 13. In the second embodiment, in addition to the function of the first embodiment, a new function to evaluate the energy saving behavior based on the external condition such as a temperature and a stay time of person is prepared.

At S6 (data measurement), in the same way as the first embodiment, an electric power and a metrics of the home appliance are measured. Furthermore, the external condition (a temperature, a humidity, an illuminance, a stay time of person, a time to go home) affecting on the electric energy consumption and the metrics of the home appliance is measured.

In the second embodiment, the external condition includes six items, i.e., “outdoor temperature”, “outdoor humidity”, “indoor temperature”, “indoor humidity”, “indoor illuminance”, and “the number of persons staying”. Five items “outdoor temperature”, “outdoor humidity”, “indoor temperature”, “indoor humidity” and “indoor illuminance” are measured by the temperature sensor 41, the humidity sensor 42 and the illuminance sensor 43. The measured values are transmitted to the external condition measurement interface 45 at a predetermined interval.

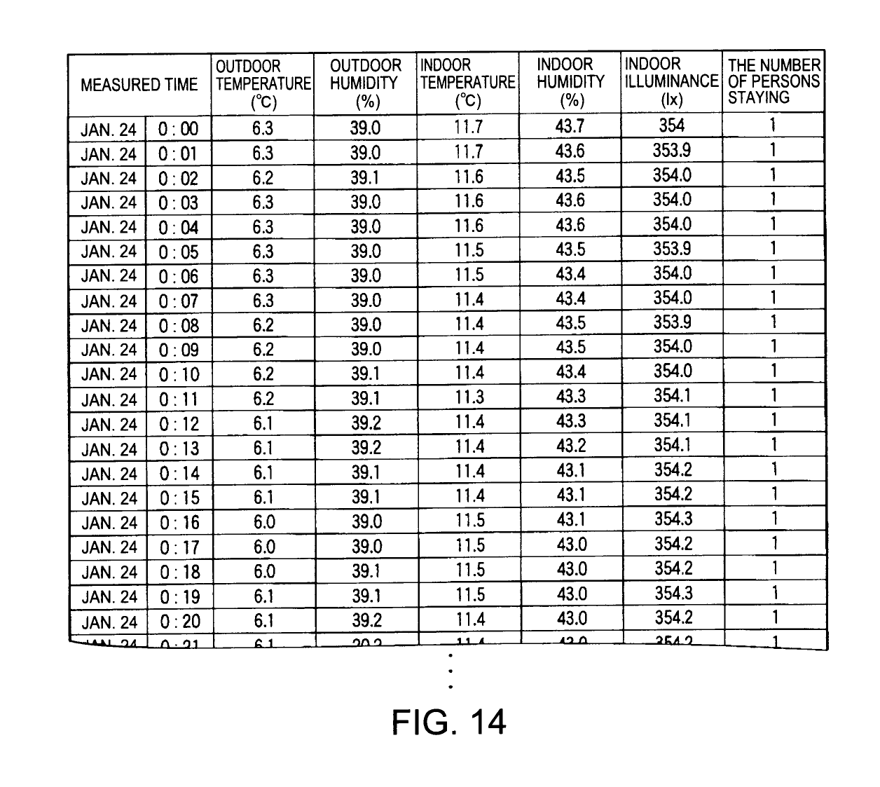

As to an item of the external condition difficult to directly measure by the sensor, a measured value of the item is estimated based on sensor data. In the second embodiment, “the number of persons staying” is difficult to directly measure. Accordingly, the number of persons staying-estimation unit 46 estimates the number of persons based on measured data from the human detection sensor 44, and transmits the estimated number of persons to the external condition measurement interface 45. In this case, measurement and transmission of data are executed every one minute. The external condition measurement interface 45 records the measured value into the external condition measured value database 47 as a format of FIG. 14.

In the second embodiment, data measurement (S6) is executed at a measurement interval (every one minute), and other steps (such as count of measured value) are executed at timing when a unit period (one day) of evaluation is completed. Accordingly, at S7 to decide completion of the unit period, it is decided whether to execute data measurement (S6) or count of measured value (S8).

At S8 (count of measured value), in the same way as the first embodiment, the appliance information count unit 34 counts the appliance measured value by the unit period of evaluation. Furthermore, the external condition count unit 48 counts the external condition measured value.

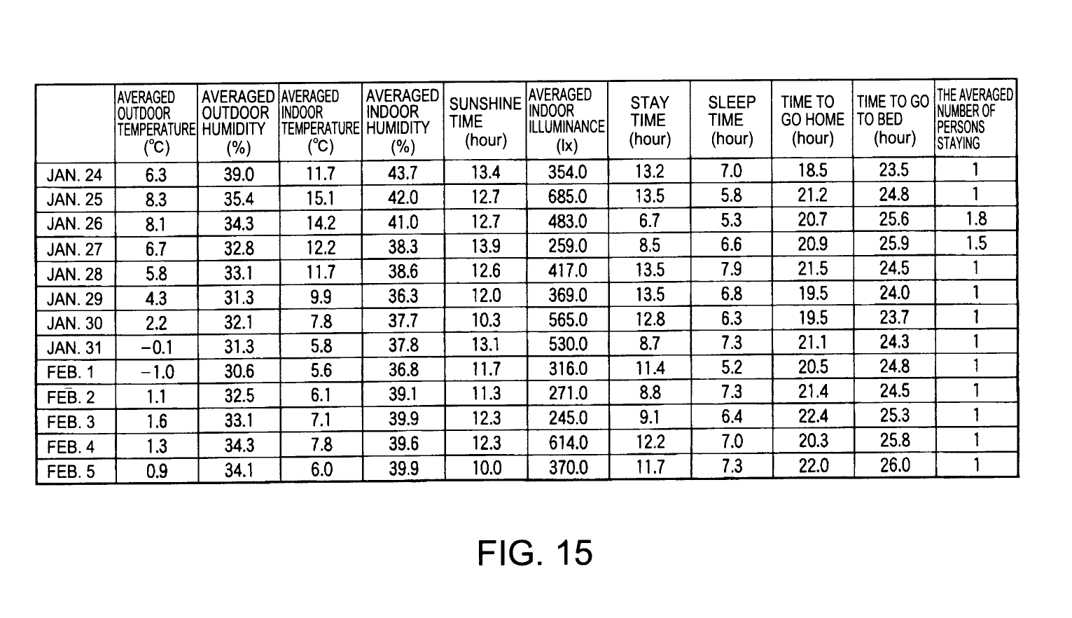

As to the measured value recorded in the external condition measured value database 47 shown in FIG. 4, the external condition count unit 48 calculates an average for one day, and records the average into the external condition database 49 as a format of FIG. 15. Furthermore, data (such as “sunshine time”) acquirable from the external database is acquired via a network. For example, the sunshine time acquisition unit 52 acquires sunshine time data of one day stored in the weather information database 51 via the network, and records the sunshine time data into the external condition database 49. As to data difficult to be measured or data for which the measurement sensor is not set, a user inputs the data. For example, “stay time of person”, “sleep time”, “time to go home” and “time to go to bed” are input by the user, and recorded into the external condition database 49.

At S9 (generation of estimation model), the estimation model generation/metrics estimation unit 53 generates a model to estimate an appliance information from external condition data of a comparison object period. In the second embodiment, the comparison object period is last week (previous one week). By referring to the external condition data for a period “January 29“˜”February 4” in FIG. 15, a model to estimate the appliance information (FIG. 5) for this period is generated for each appliance. In order to generate the estimation model, a formula of the multiple regression analysis is used. For example, as to the lighting apparatus, an equation to estimate “averaged lightness”, “lighting time” and “electric energy consumption” is represented as following equations (1)˜(3).

Averaged lightness=4×[averaged outdoor temperature]−0.1×[averaged outdoor humidity]−0.4×[averaged indoor temperature]−0.1×[averaged indoor humidity]−0.1×[sunshine time]+0.0×[averaged indoor illuminance]+0.1×[stay time of person]−0.2×[sleep time]+0.3×[time to go home]+0.3×[time to go to bed]−0.1×[averaged number of persons staying]−5.79 (1)

Lighting time=4×[averaged outdoor temperature]−0.0×[averaged outdoor humidity]−0.3×[averaged indoor temperature]+0.2×[averaged indoor humidity]+0.6×[sunshine time]+0.0×[averaged indoor illuminance]+0.4×[stay time of person]−0.9×[sleep time]−0.4×[time to go home]+0.4×[time to go to bed]−2.9×[averaged number of persons staying]−1.2 (2)

Electric energy consumption=351.34×[averaged lightness]+213.57×[lighting time]−736.865 (3)

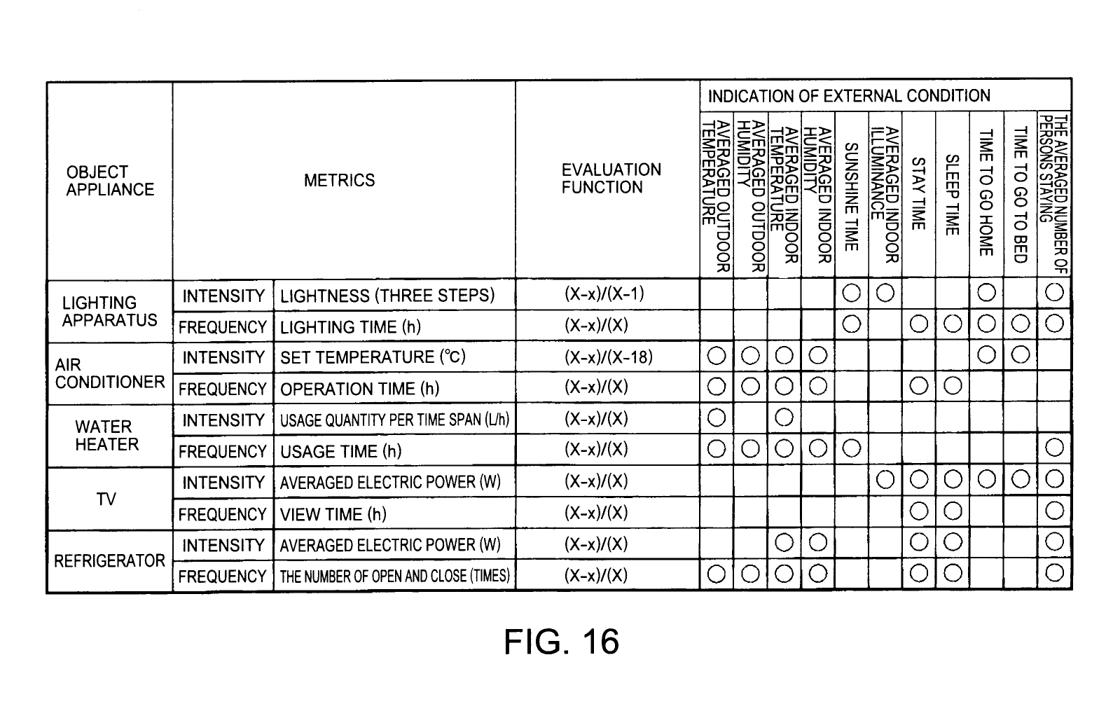

Furthermore, in case of generating the estimation model, items of the external condition related with a metrics to be estimated may be previously indicated in the metrics database 37 as a format of FIG. 16. In this case, indicated items of the external condition are only used for estimation.

At S10 (metrics estimation), the estimation model generation/metrics estimation unit 53 estimates a metrics and an electric energy consumption of each appliance using the estimation model (generated at S9), from the external condition data of an evaluation object period. In the second embodiment, the evaluation object period is yesterday (previous one day). Accordingly, from the external condition data of “February 5” stored in the external condition database 49, the metrics and the electric energy consumption of each appliance are estimated using the estimation model (generated at S9). For example, in case of the lighting apparatus, the averaged lightness, the lighting time and the electric energy consumption are respectively estimated as 2.83 (step), 5.25 (h) and 1226.79 (41h) using the equations (1)˜(3). The data estimated by the estimation model generation/metrics estimation unit 53 is sent to the energy saving behavior-evaluation unit 36.

At S11 (evaluation of energy saving behavior), the energy saving behavior-evaluation unit 36 evaluates an energy saving behavior using the appliance information and the estimated data (from the estimation model generation/metrics estimation unit 53). Briefly, in the behavior evaluation apparatus 31 of the second embodiment, the evaluation object period is yesterday, and the comparison object period is last week. Measured values (of metrics and electric energy consumption) of yesterday are compared with estimated values (of metrics and electric energy consumption) of yesterday estimated using the estimation model generated from measured values of last week. Based on this comparison result, the energy saving behavior of yesterday is evaluated.

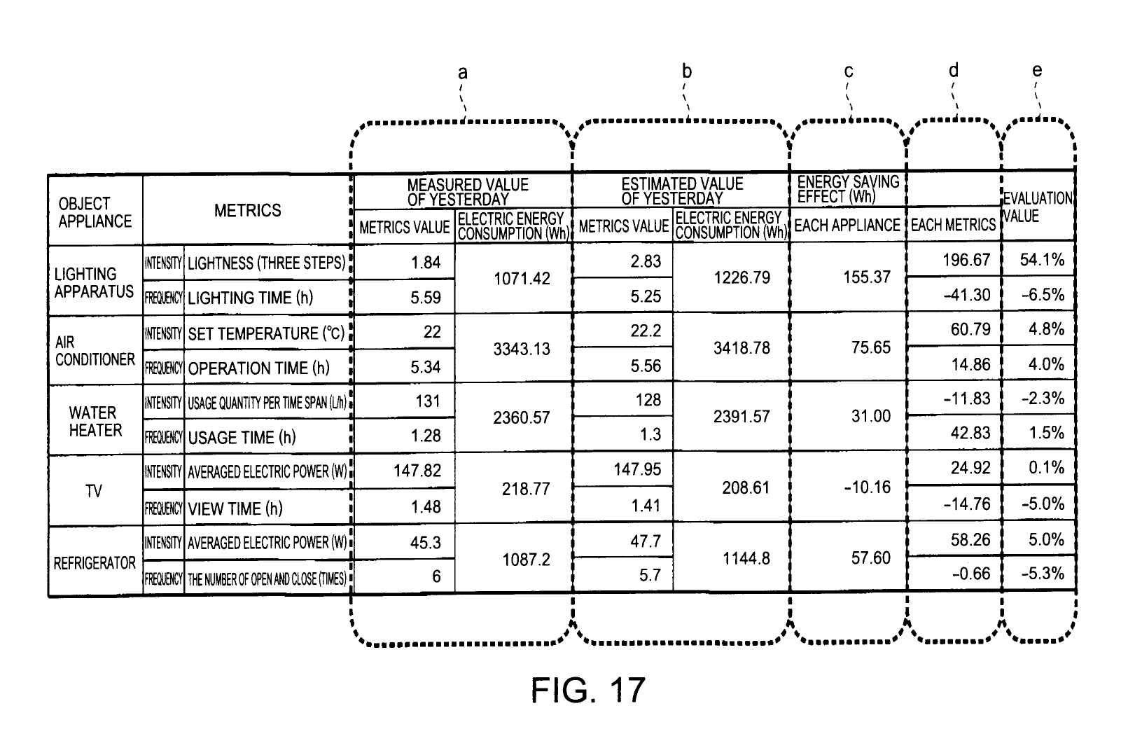

Concretely, the energy saving behavior-evaluation unit 36 acquires a measured value of yesterday (Feb. 25) from the appliance information database 35, and records the measured value into the evaluation result database 38 (“a” in FIG. 17). Furthermore, an estimated value of yesterday (sent from the estimation model generation/metrics estimation unit 53) is recorded into the evaluation result database 38 (“b” in FIG. 17). A difference of the electric energy consumption of yesterday between the measured value and the estimated value is recorded as an energy saving effect into the evaluation result database 38 (“c” in FIG. 17).

In the estimation model of the electric energy consumption of last week (generated by the estimation model generation/metrics estimation unit 53), if a contribution ratio of the usage intensity metrics and the usage frequency metrics to the electric energy consumption is respectively known as the equation (3), the energy saving effect may be distributed by each metrics and recorded into the evaluation result database 38 (“d” in FIG. 17). As a method for distributing the energy saving effect, for example, the energy saving effect of the usage intensity metrics of the lighting apparatus is calculated by following equation (4).

Energy saving effect of usage intensity metrics=[|energy saving effect of the appliance|×(coefficient of first term in equation (3))×{(estimated value of usage intensity metrics)−(measured value of usage intensity metrics)}]÷[(coefficient of first term in equation (3))×{(estimated value of usage intensity metrics)−(measured value of usage intensity metrics)}+(coefficient of second term in equation (3)×{(estimated value of usage frequency metrics)−(measured value of usage frequency metrics)}] (4)

Last, in the same way as the first embodiment, an evaluation value of each appliance is calculated using the evaluation function stored in the metrics database 37, and recorded into the evaluation result database 38 (“e” in FIG. 17).

At S12 (display of evaluation result), the evaluation result display unit 40 displays the evaluation result of the energy saving behavior for the evaluation object period to a user, based on the evaluation value and the advice data.

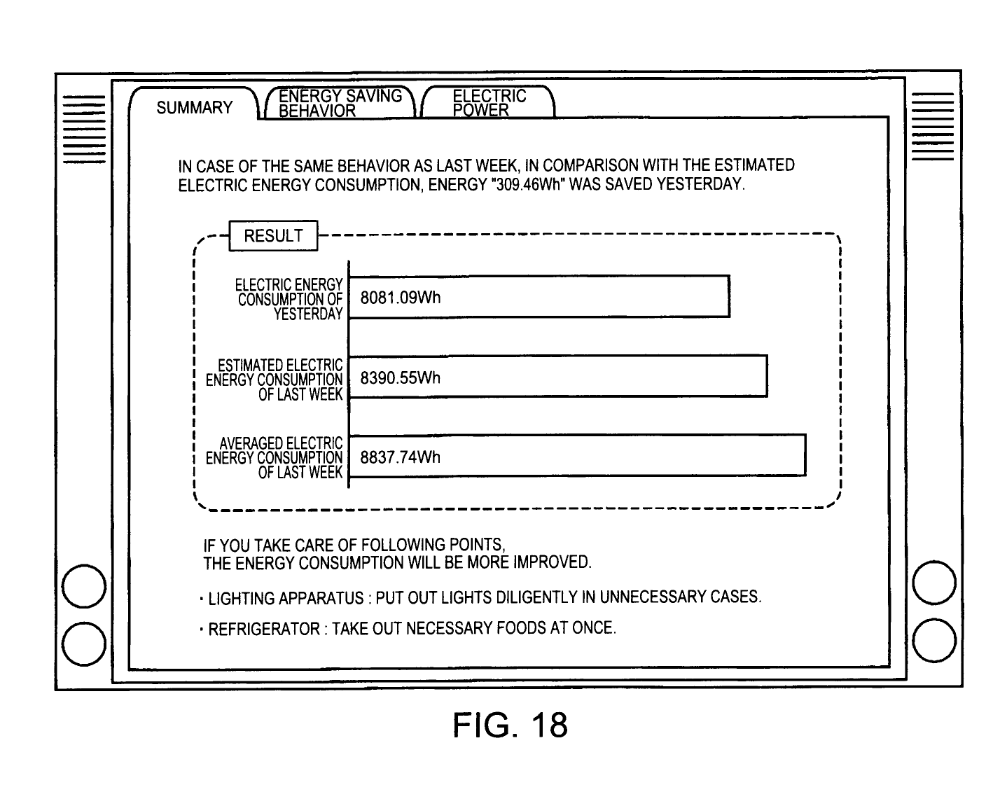

In the second embodiment, in the same way as the first embodiment, by displaying information of three kinds on a display terminal based on the evaluation result database 38, the evaluation result is presented to the user. A display example of FIG. 18 is same as FIG. 9 of the first embodiment. In the display example of FIG. 18, in addition to FIG. 9, both an estimated value and a measured value (average for one day) of the electric energy consumption of last week (comparison object period) are displayed as a bar graph.

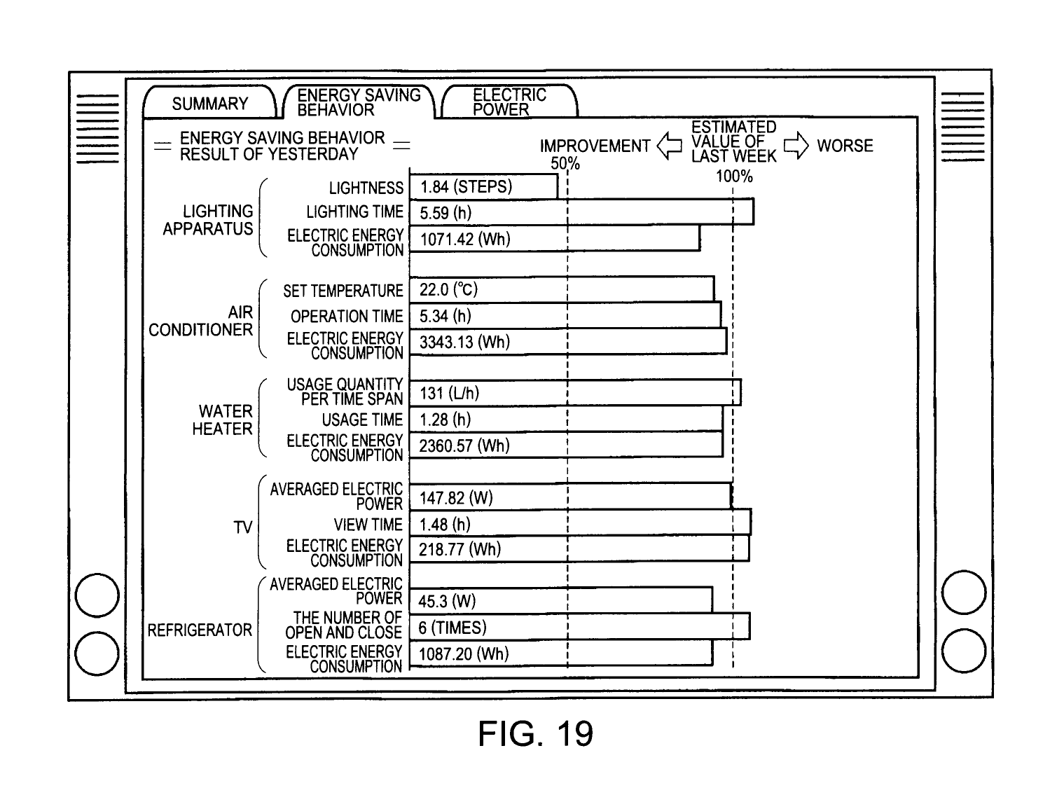

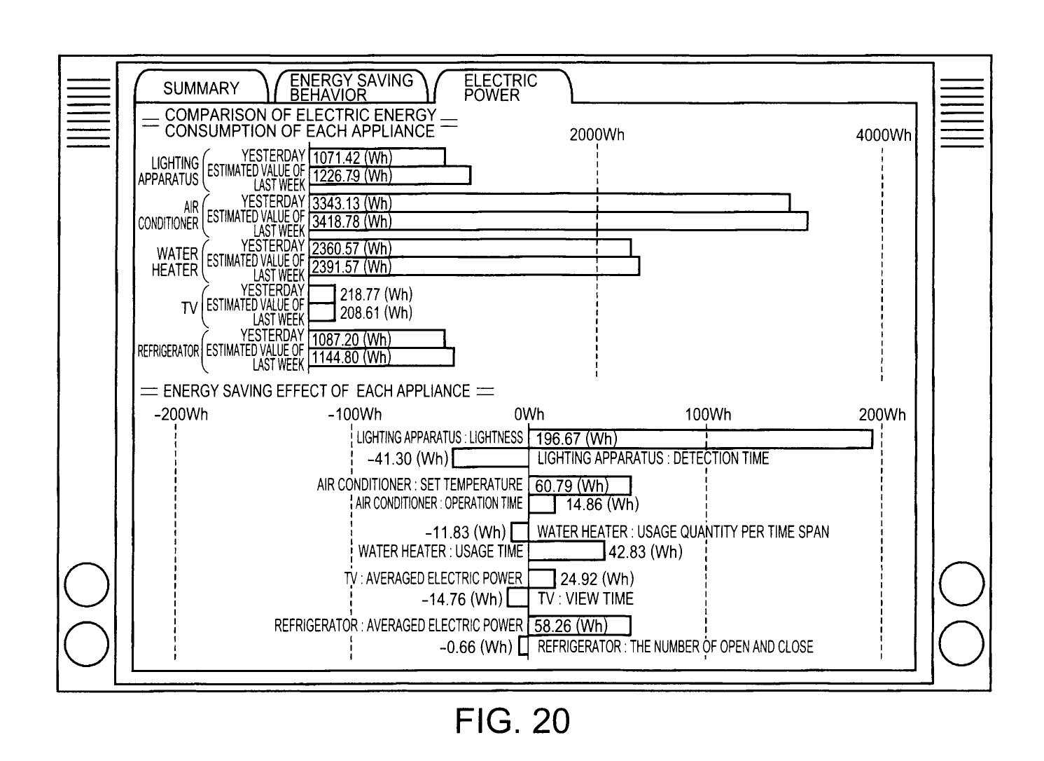

In another display example of FIG. 19, in the same way as FIG. 10, the estimated value of last week is set as 100%, and a ratio of the measured value of yesterday to the estimated value is displayed as a bar graph. In the other display example of FIG. 20, in the same way as FIG. 11, the energy saving effect of each appliance is displayed as a bar graph.

In the second embodiment, a metrics to measure the energy saving behavior by decrease of the usage frequency, and a metrics to measure the energy saving behavior by adjustment of the usage intensity, are set for each appliance. By comparing a measured value of the metrics of each appliance, an enforcement degree of the energy saving behavior is evaluated.

Furthermore, the estimation model of each metrics is generated from measured data in the past. A metrics is estimated using the estimation model, from the external condition (such as the temperature, the humidity, the stay time of person, the number of persons staying) measured in an evaluation object period. By comparing a metrics actually measured in the evaluation object period with the estimated metrics, the enforcement degree of the energy saving behavior is evaluated.

As mentioned-above, by comparing the metrics (the electric energy consumption) excluding influence of the external condition, effect of the energy saving behavior itself can be understood. Briefly, as to the energy saving behavior, the evaluation can be exhaustively realized by considering both the usage frequency and the usage intensity. Furthermore, the evaluation can be properly realized by considering factors (the temperature, the humidity, the stay time of person, the number of persons staying) affecting on usage of the appliance.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for evaluating an energy saving behavior, comprising:
an appliance measurement interface configured to input an appliance measured value from each appliance, the appliance measured value including an electric energy consumption, a usage intensity and a usage frequency of the appliance;
an appliance measured value database configured to store the appliance measured value;
an appliance information count unit configured to calculate an average of the appliance measured value in an evaluation span;
an appliance information database configured to store an appliance information as the average of the appliance measured value;
an evaluation unit configured to acquire a first appliance information in a first evaluation span and a second appliance information in a second evaluation span from the appliance information database, and calculate an evaluation value by applying the first appliance information and the second appliance information to an evaluation function, the first evaluation span being an evaluation object period, the second evaluation span being a comparison object period;
an evaluation result database configured to store the evaluation value; and
a display unit configured to display an evaluation result of the energy saving behavior based on the evaluation value.

2. The apparatus according to claim 1, further comprising:
an external condition measurement interface configured to input an external condition measured value from each sensor, the external condition measured value including a temperature, a humidity, a sunshine time and a stay time of a person in a usage environment of the appliance;
an external condition measured value database configured to store the external condition measured value;
an external condition count unit configured to calculate an average of the external condition measured value in the evaluation span;
an external condition database configured to store an external condition data as the average of the external condition measured value; and
an estimation unit configured to estimate the second appliance information using the external condition data;
wherein the evaluation unit calculates the evaluation value using the second appliance information estimated by the estimation unit.

3. The apparatus according to claim 1, wherein
the usage intensity includes a set temperature and an electric power, and
the usage frequency includes a usage time and the number of use.

4. The apparatus according to claim 1, wherein
the appliance measurement interface inputs the appliance measured value every one minute, and
the appliance information count unit calculates an average of the appliance measured value inputted every one minute in one day.

5. The apparatus according to claim 1, wherein
the evaluation unit calculates an improvement value of metrics by subtracting an evaluation object metrics value x of the first appliance information from a comparison object metrics value X of the second appliance information, calculates a difference value by subtracting a minimum of metrics from the comparison object metrics value X, and calculates the evaluation value by dividing the improvement value with the difference value.

6. The apparatus according to claim 1, further comprising:
an advice database configured to store an advice data corresponding to the evaluation value;
wherein the evaluation result display unit displays the advice data corresponding to the evaluation value by extracting from the advice database.

7. A method for evaluating an energy saving behavior, comprising:
inputting an appliance measured value from each appliance, the appliance measured value including an electric energy consumption, a usage intensity and a usage frequency of the appliance;
storing the appliance measured value into an appliance measured value database;
calculating an average of the appliance measured value in an evaluation span;
storing an appliance information as the average of the appliance measured value into an appliance information database;
acquiring a first appliance information in a first evaluation span and a second appliance information in a second evaluation span from the appliance information database, the first evaluation span being an evaluation object period, the second evaluation span being a comparison object period;
calculating an evaluation value by applying the first appliance information and the second appliance information to an evaluation function;
storing the evaluation value into an evaluation result database; and
displaying an evaluation result of the energy saving behavior based on the evaluation value.

8. The method according to claim 7, further comprising:
inputting an external condition measured value from each sensor, the external condition measured value including a temperature, a humidity, a sunshine time and a stay time of a person in a usage environment of the appliance;
storing the external condition measured value into an external condition measured value database;
calculating an average of the external condition measured value in an evaluation span;
storing an external condition data as the average of the external condition measured value into an external condition database; and
estimating the second appliance information using the external condition data;
wherein a step of the calculating includes calculating the evaluation value using the second appliance information estimated at a step of the estimating.

9. The method according to claim 7, wherein
the usage intensity includes a set temperature and an electric power, and
the usage frequency includes a usage time and the number of use.

10. The method according to claim 7, wherein
a step of the inputting includes inputting the appliance measured value every one minute, and
a step of the calculating an average includes calculating an average of the appliance measured value inputted every one minute in one day.

11. The method according to claim 7, wherein
a step of the evaluating includes calculating an improvement value of metrics by subtracting an evaluation object metrics value x of the first appliance information from a comparison object metrics value X of the second appliance information, calculating a difference value by subtracting a minimum of metrics from the comparison object metrics value X, and calculating the evaluation value by dividing the improvement value with the difference value.

12. The method according to claim 7, further comprising:
storing an advice data corresponding to the evaluation value into an advice database;
wherein a step of the displaying includes displaying the advice data corresponding to the evaluation value by extracting from the advice database.
